(19) United States
(12) Patent Application Publication
(10) Pub. No.: US 2014/0126732 A1
(43) Pub. Date: May 8, 2014

(54) ACOUSTIC MONITORING SYSTEM AND METHODS

(71) Applicant: The Johns Hopkins University, Baltimore, MD (US)

(72) Inventors: James E. West, Plainfield, NJ (US); Dimitra Emmanouilidou, Baltimore, MD (US); Victor Ekanem, Baltimore, MD (US); Hyesang Lee, Baltimore, MD (US); Peter Lucia, Carlisle, PA (US); Mounya Elhilali, Silver Spring, MD (US); Kunwoo Kim, Baltimore, MD (US)

(73) Assignee: The Johns Hopkins University, Baltimore, MD (US)

(21) Appl. No.: 14/062,586

(22) Filed: Oct. 24, 2013

Related U.S. Application Data
(60) Provisional application No. 61/718,034, filed on Oct. 24, 2012.

(51) Int. Cl. H04R 1/46

(52) U.S. Cl. CPC H04R 1/46
USPC 381/67

(57) ABSTRACT

An electronic stethoscope includes an acoustic sensor assembly having a plurality of microphones arranged in an acoustic coupler to provide a plurality of pick-up signals. The electronic stethoscope also includes a detection system to communicate with the acoustic sensor assembly and to combine the plurality of pick-up signals to provide a detection signal. The electronic stethoscope also includes an output system to communicate with the detection system. The acoustic coupler uses a compliant material that forms an acoustically tight seal with a body under observation.

### CROSS-REFERENCE OF RELATED APPLICATION

This application claims priority to U.S. Provisional Application No. 61/718,034 filed Oct. 24, 2012, the entire contents of which are hereby incorporated by reference.

### STATEMENT OF GOVERNMENT SUPPORT

This invention was made with U.S. Government support of Grant No. 112361, awarded by NASA. The U.S. Government has certain rights in this invention.

### TECHNICAL FIELD

The field of the currently claimed embodiments of this invention relates to systems and methods for acoustic monitoring, particularly for acoustic monitoring of bodily functions preferentially over unwanted sounds and for differentiating among different sounds.

### BACKGROUND

Accurate medical diagnosis relies on the efficient distinction between what is considered normal and abnormal through visual or acoustic methods. A wide variety of medical devices exist for visualization of body tissue, bone structure or blood flow as well as for recording electrical or potential signals of brain or heart functionality. Such methods usually allow accurate detection of normal or abnormal cases, with normal indicating a healthy patient, and abnormal indicating injury, organ dysfunction or illness. Other diagnostic techniques (in fact, the very first means of medical diagnosis used by humans) exploit the audio acoustic nature of signals produced by our human body. Breathing, coughing and more general lung sounds may be used to determine the physiology or pathology of lungs and reveal cases of airway obstruction or pulmonary disease.

Auscultation involves listening to internal sounds of a subject's body and may be performed using a stethoscope. However, the ability to listen to and identify various noises can be hampered by the presence of noise from various sources. Unwanted sounds can corrupt the desired signals causing false or incorrect diagnosis. In a traditional acoustic stethoscope, noise contaminates the desired signal at three points: at the stethoscope head, through the hose, and at the ear of the user. Monitoring body sounds in the presence of high noise fields represents a problem in field studies of infant lung sounds in underdeveloped countries, for example. Another noisy venue where noise levels are high is on space vehicles, such as on the NASA Man Mars Spaceship, where monitoring uncorrupted body sounds will be important for the health of the astronauts. On space vehicles, noise impinges on the listener's ear from both ambient noise and relative motion at the sensor on the patient's body. Emergency medical service (EMS) environments are also noisy and render normal stethoscopes useless.

In the above environments and others, factors such as untrained health care providers, subjectivity in interpreting respiratory sounds or even limitations of human audition can be suppressed via the improved design of an electronic stethoscope, and also by automated analysis of signals detected by an electronic stethoscope. Early and accurate detection would lead to better individualized treatment of patients and avoid use of unnecessary medication.

### SUMMARY

An electronic stethoscope according to an embodiment includes an acoustic sensor assembly, a detection system that communicates with the acoustic sensor assembly, and an output system that communicates with the detection system. The acoustic sensor assembly includes a plurality of microphones arranged in an acoustic coupler to provide a plurality of pick-up signals. The detection system combines the plurality of pick-up signals to provide a detection signal. Additionally, the acoustic coupler includes a compliant material that forms an acoustically tight seal with a body under observation.

An electronic stethoscope according to another embodiment includes an acoustic sensor assembly, a detection system that communicates with the acoustic sensor assembly, and an output system that communicates with the detection system. The acoustic sensor assembly according to this embodiment includes a microphone arranged in an acoustic coupler to provide a detection signal from a body under observation, and a microphone arranged external to the acoustic coupler to receive external acoustic signals from sources that are external to the body under observation. According to this embodiment, at least one of the detection system and the output system may correct the detection signal based on the external acoustic signals.

According to another embodiment, a method for processing signals detected by an electronic stethoscope from a body under observation is provided. The method includes obtaining a signal captured by the electronic stethoscope, and identifying a part of the signal that corresponds to at least one of a noise external to the body under observation and an internal sound of the body. Additionally, the method can include optionally removing at least a portion of the part of the signal that is identified.

### BRIEF DESCRIPTION OF THE DRAWINGS

Further objectives and advantages will become apparent from a consideration of the description, drawings, and examples.

FIG. 1 shows an acoustic sensor assembly of an electronic stethoscope according to an embodiment of the current invention.

FIG. 2 shows a microphone array on the bottom of an acoustic sensor assembly according to an embodiment of the current invention.

FIG. 3 is a schematic illustration of various embodiments of the current invention that have differently configured output systems, including (1) headphones, (2) storage on a portable USB drive, or (3) storage on a computer connected to the electronic stethoscope via Bluetooth.

FIG. 4 shows an example of a Bluetooth adapter circuit board according to an embodiment of the current invention.

FIG. 5 shows a schematic of an example of a summation amplifier circuit board according to an embodiment of the current invention.

FIG. 6 is an example of a graph of the signal of a heartbeat detected with the device in FIG. 1.

FIG. 7A shows a graph of an excerpt of a lung sound recording, acquired from a “normal” patient.

FIG. 7B shows a time-frequency representation of another recording, revealing the breathing cycle (indicated by arrows).

FIG. 8 shows a graph of an excerpt of a lung sound recording with an apparent heart beat.

FIG. 9A shows a signal of a recording containing crackle segments around 2 and 3.5 seconds.

FIG. 9B shows a zoomed-in view of the signal shown in FIG. 9A.

FIG. 10 shows a graph of a time-frequency (TF) representation of a 15 second segment of a recording.

FIGS. 11A-11K show representations of segments from a study, including segments showing (A) a noisy interval between seconds one and two; (B) coughing at the fourteenth and fifteenth second; (C) full contamination by background crying and talking; (D) possible wheezes at zero, six, and ten and a half seconds, as well as crackles; (E) possible wheezes; (F) crackles; (G) wheezes after the tenth second; (H) noise and possibly wheeze; (I) crackles and background talking; (J) crackles and very fast breathing; and (K) appearance of crying or conductive noise.

FIG. 12 shows visualizations of a 15 second recorded segment having a heart beat visible through the frequency-time representation.

FIG. 13 shows the signal of FIG. 12 after processing by decomposing the signal at level seven, including (from top to bottom): (1) the original excerpt; (2) the signal reconstruction based only on A7 coefficients; (3) the reconstruction based only on D7 coefficients; (4) the reconstruction excluding A7 coefficients; and (5) the reconstruction excluding both A7 and D7 coefficients.

FIG. 14 shows a reconstruction of the signal from FIG. 12 by excluding coefficients A7 and D7.

FIG. 15 shows a spectrogram of the signal of FIG. 12 after being reconstructed using only coefficient A7.

FIG. 16 shows representations of a 15-second segment containing crackling.

FIG. 17 shows the signal of FIG. 16 after processing by decomposing the signal at level seven, including (from top to bottom): (1) the original excerpt with crackling; (2) the signal reconstruction based only on A7 coefficients; (3) the reconstruction based only on D7 coefficients; (4) the reconstruction excluding A7 coefficients; and (5) the reconstruction excluding both A7 and D7 coefficients.

FIG. 18 shows time-frequency and rate-scale representations of data used in the study.

FIG. 19 shows an acoustic sensor assembly of an electronic stethoscope according to an embodiment of the current invention.

FIG. 20 shows a cross-section of the embodiment of the acoustic sensor assembly shown in FIG. 19.

FIG. 21 shows an example of a bottom of an electronics case in the acoustic sensor assembly of FIG. 19.

FIG. 22 shows an example of a top of an electronics case in the acoustic sensor assembly of FIG. 19.

FIG. 23 shows a housing of the transducer using in the acoustic sensor assembly of FIG. 19.

FIG. 24 shows a cross-section of the housing of FIG. 23 and the transducer.

FIG. 25 shows a second cross-section of the housing of FIG. 23 and the transducer.

FIG. 26 shows a close-up cross-section of the transducer used in the acoustic sensor assembly of FIG. 19.

FIG. 27 shows a schematic of an electronic stethoscope according to an embodiment of the current invention.

FIG. 28 shows a schematic of a detection system and output system of an electronic stethoscope according to an embodiment of the current invention.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

As noted above, detection and analysis of a desired signal can be contaminated by noise at three points: at the stethoscope head, through the hose, and at the ear of the user. According to some embodiments of the current invention, noise at all three points can be mitigated by, for example, better coupling to the body, elimination of a rubber hose, and by using noise cancelling headphones at the listener's ear. Noise and unwanted body sounds can be further reduced by digital signal processing (DSP). DSP can be combined with the above-discussed mechanical techniques according to some embodiments of the current invention. In some embodiments, DSP can be used not only to reduce unwanted sounds, but to help identify various sounds.

Accordingly, some embodiments of the current invention can provide systems and methods to monitor and record sounds from the human body, including heart, lung, and other emitted sounds in the presence of high noise using multi-sensor flexible auscultation instruments used to detect a desired signal, as well as methods to seal the pickup device of the instrument to the body to reduce external noise from contaminating the desired signal. DSP according to some embodiments can include noise cancelling techniques by processing external noise picked up by a microphone exposed to noise near the auscultation instrument. Additional DSP to classify differences between subjects can be employed according to some embodiments to help identify potential problems in the lung or other sound emitting organs.

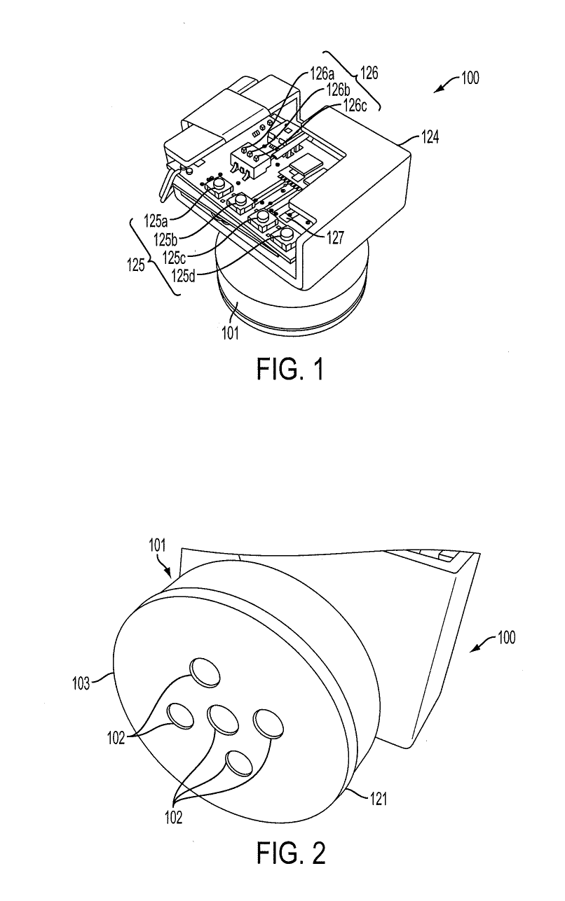

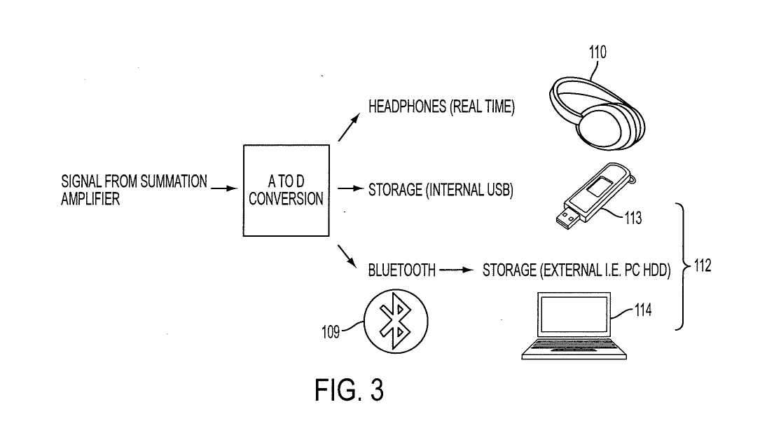

FIG. 1 shows an electronic stethoscope 100 according to an embodiment of the current invention.

The electronic stethoscope 100 includes an acoustic sensor assembly 101 having a plurality of microphones 102 arranged in an acoustic coupler 103 to provide a plurality of pick-up signals. Piezoelectric polymers may also be used in place of the plurality of microphones. The electronic stethoscope 100 also includes a detection system 104 and an output system 105. The detection system 104 communicates with the acoustic sensor assembly 101 and combines the plurality of pick-up signals to provide a detection signal 106. The output system 105 communicates with the detection system 104. The acoustic coupler 103 is made of a compliant material 121 that forms an acoustically tight seal with a body under observation.

The phrase “acoustically tight” seal in reference to the acoustic coupler means that it obtains a decrease in the amount of ambient noise from outside the body under observation compared to a conventional stethoscope, such as a non-compliant metal component.

The plurality of microphones 102 can include any number of microphones. FIG. 2 shows an embodiment having five microphones. However, the plurality of microphones can contain more or fewer microphones. For example, six microphones may be used. The plurality of microphones 102 may be electret microphones, or some other type of microphone suitable for auscultation, for example. The plurality of microphones can be replaced by an inverted electret microphone, or piezo-active polymers such as polyvinylidene-fluoride (PVDF), or poly(γ-benzyl-L-glutamate) (PBLG).

As shown in FIG. 2, the plurality of microphones 102 is placed within the compliant material 121. Accordingly, the microphones may be positioned securely while the stethoscope is guided over the skin of a patient. The compliant material 121 may be, for example, rubber. However, the compliant material 121 is not limited to rubber, and may be any polymer, composite, or other material suitable for achieving an acoustically tight seal for the acoustic coupler 103.

The detection system 106 may also include a wireless transmitter 107 and the output system may correspondingly include a wireless receiver 108. Thus, a wireless communication link 109 may be provided between the detection system 106 and the output system 107. The wireless transmitter 107 may be a radio frequency wireless transmitter, including, for example, a Bluetooth radio frequency wireless transmitter. Additionally, the wireless receiver 108 may be a radio frequency wireless receiver, including, for example, a Bluetooth radio frequency wireless receiver.

The output system 105 may include headphones 110, which may include the wireless receiver 108 to provide the wireless communication link 109 between the detection system 104 and the headphones 110. Thus, the headphones 110 may be a wireless-type headphone, including a Bluetooth-enabled headphone. Alternatively, the detection system 106 and the headphones 110 may communicate over a hard-wired communication link 111 using at least one of an electrical wire or an optical fiber, for example.

The output system 105 may also include a data storage device 112. The data storage device 112 may be comprised of any known storage device, including a removable data storage component 113 or a computer 114.

At least one of the plurality of microphones 102 may be arranged external to the acoustic coupler 103 to receive external acoustic signals from sources that are external to the body under observation. At least one of the detection system 104 and the output system 105 may be further configured to perform a correction of the detection signal 106 based on the external acoustic signals. The correction may include at least partially filtering the external acoustic signals from the detection signal 106. The correction may be based, for example, on a waveform characteristic of the external acoustic signal.

The output system 105 may include a data processing system 116 configured to perform an identification of at least one of a physical process and a physiological condition of the body based on the detection signal 106. The identification may be based, for example, on at least one of a temporal characteristic and a spectral characteristic of the detection signal 106.

The output system 105 may be further configured to provide aural or visual feedback to a user of the electronic stethoscope 100.

According to an embodiment, the electronic stethoscope 100 includes an acoustic sensor assembly 101 including a microphone 117 arranged in an acoustic coupler 103 to provide a detection signal 106 from a body under observation, and a microphone 115 arranged external to the acoustic coupler 103 to receive external acoustic signals from sources that are external to the body under observation. The electronic stethoscope 100 of this embodiment also includes a detection system 104 configured to communicate with the acoustic sensor assembly 101 and an output system 105 configured to communicate with the detection system 104. At least one of the detection system 104 and the output system 105 is further configured to perform a correction of the detection signal 106 based on the external acoustic signals.

The correction may at least partially filter the external acoustic signals from the detection signal 106. In addition, the correction may be based on a characteristic of at least one of the external acoustic signal and the detection signal 106.

An embodiment of the current invention is a method for processing signals detected by an electronic stethoscope 101 from a body under observation. The method comprises obtaining a signal captured by the electronic stethoscope 101, identifying a part of the signal that corresponds to at least one of a noise external to the body under observation and an internal sound of the body, and optionally removing at least a portion of the part of the signal. The part of the signal can be identified according to at least one of a frequency characteristic and a time characteristic of the part of the signal. The part of the signal can also be identified based on a reference signal.

“Identifying” as used in the method of this embodiment may include recognizing and/or labeling a source of the part of the signal, or merely differentiating that part of the signal from some remainder of the signal.

The method for processing signals may further include performing a discrete wavelet transformation of the signal. The transformation can include filtering the signal in a number of steps. Each step includes (1) applying a high-pass filter and a low-pass filter to the signal, (2) obtaining a first coefficient and a second coefficient as a result of applying the high-pass filter and the low-pass filter, respectively, and (3) downsampling the signal after applying the high- and low-pass filters. The transformation also includes transforming the signal based on at least one the first coefficient and the second coefficient obtained from at least one of the steps of filtering. For example, the transformation may include or exclude only the first coefficient from a particular filtering level, or only the second coefficient from a particular filtering level, or a combination of the first and second coefficients from one or more particular filtering levels.

Various forms of signal processing, including those for noise cancellation and filtering and/or identifying sounds in the signal, can be automated in either the electronic stethoscope or a device storing the signal detected by the electronic stethoscope. Such an automated system can be used to aid in detecting and identifying physical processes or physiological conditions within a body. For example, based on lung sounds detected by the electronic stethoscope 100, an automated system can be used to detect respiratory illnesses, classify them into clinical categories using specific characteristics and features of lung sounds, and diagnose the severity or cause of a possible pulmonary dysfunction. In this, the advantages provided by the electronic stethoscope 100 as well as the signal processing can compensate for untrained health care providers, subjectivity in interpreting respiratory sounds, or limitations of human audition.

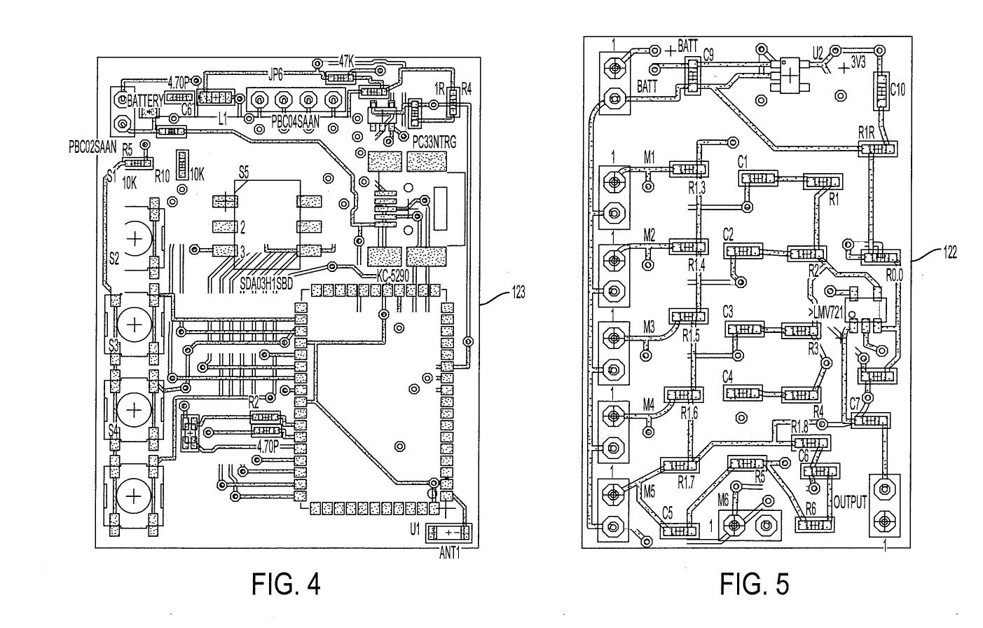

FIG. 5 shows a schematic of an example of a circuit board for a summation amplifier 122 according to an embodiment. Wires from the batteries used to power the electronic stethoscope 100, including the plurality of microphones 102, are fed to the summation amplifier 122 and soldered directly onto the summation amplifier 122. On the summation amplifier 122, the signals from each of the plurality of microphones 102 are combined and amplified. The amplification may be at a gain of about 1.5, for example. The signal is shielded with a decoupling capacitor on the summation amplifier 122 before going to any number of output mechanisms. In one embodiment, for example, the signal goes to the Bluetooth adapter circuit 123 shown in FIG. 4. Once the signal arrives at the Bluetooth adapter circuit 123, it goes to a small Bluetooth adapter that can stream it wirelessly to a standard A2DP stereo compatible Bluetooth headset or computer. A signal sent via Bluetooth can thus be recorded, or sent directly to a jack of a noise cancelling headphone 110 for live playback of the signal.

In some embodiments, a microcontroller (not shown) can be incorporated into the electronic stethoscope 100 so that recordings can be stored directly on the device or on a portable USB stick 113. Circuitry in alternative embodiments also can support built-in signal processing algorithms that may help a medical officer make a diagnosis.

The following is a description of the operation of the embodiment of the electronic stethoscope 100 shown in FIG. 1. The top of a housing 124 of the electronic stethoscope 100 shown in FIG. 1 is cut out to allow a user access to switches 125 and 126 on the top of the electronic stethoscope 100. The housing 124 may be sanded or filleted to remove sharp edges. Other embodiments may use a different housing which can incorporate an LED screen. The embodiment in FIG. 1 has push button switches 125 (four shown as 125a-125d) and a three-pin switch 126 that allow the user to control the device. However, different numbers and configurations of switches are possible.

In order to provide power to both circuit boards shown in FIGS. 4 and 5, the user first slides pin 3 126c of the 3-pin switch 126. Holding down the first push button switch 125a for at least 2.5 seconds allows the user to turn the device on or off. Once the device turns on it immediately searches for a headset to connect to and a light emitting diode (LED) 127 blinks rapidly. The electronic stethoscope 100 in FIG. 1 runs on a single battery source. However, the device can also receive power and/or recharge the battery via a USB port (not shown). The USB port can also be used to download firmware updates to the Bluetooth adapter.

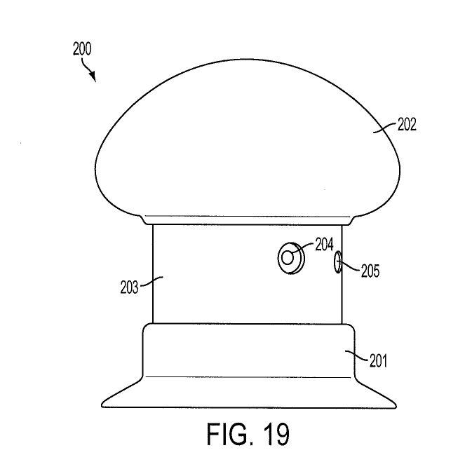

FIG. 19 shows an electronic stethoscope 200 according to another embodiment of the current invention. The electronic stethoscope 200 may include a bottom cover 201, top cover 202, and electronics case assembly 203. The electronic stethoscope 200 may also include a variety of controls, ports, and indicators, such as an LED 204 and headphone jack 205, as shown on the electronics case assembly 203 in FIG. 19.

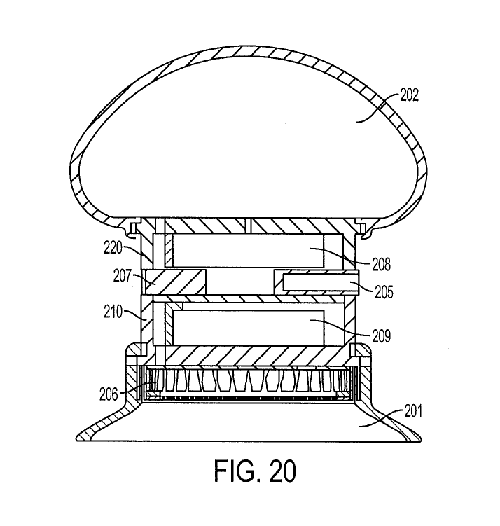

The electronic stethoscope 200 of FIG. 19 is shown in cross-section in FIG. 20 revealing the interior of the electronics case assembly 203 and the transducer 206. The electronics case assembly 203 can house electronics 208 and batteries 209. As shown in FIG. 20, the electronics case assembly 203 can also include a power jack 207.

The interior of the bottom cover 201 and top cover 202 can be, for example, hollow, as shown in the embodiment of FIG. 20. In one embodiment, it is contemplated that a negative pressure can be created within at least the bottom cover 201 when the electronic stethoscope 200 is in use and the bottom cover 201 is in contact with a patient. In such a case, auscultation can be performed using a hands-free operation of the electronic stethoscope 200, thereby eliminating noise from hand movements during data collection. Such an embodiment may be useful when using the device with infants, for example.

In one embodiment, the bottom cover 201 and top cover 202 may be made from urethane rubber, for example, and both covers 201, 202 may be securely connected to the electronics case assembly 203.

In addition, the electronics case assembly 203 can be made of a bottom electronics case 210 and a top electronics case 220. FIG. 21 shows an example of the bottom electronics case 210, which includes a headphone jack hole 216, an LED hole 217, and a power jack slot 221. The bottom electronics case 210 may also include a trim pot slot 212 to accommodate a trim pot (not pictured) in the electronics within the electronics case assembly 203. Within the bottom electronics case 210 can be one or more hubs 214 and each hub 214 may have a screw hole 215. It is understood that a hole for accommodating some other suitable attachment member other than a screw can be provided. The bottom of the bottom electronics case 210 can include a connection ring 213.

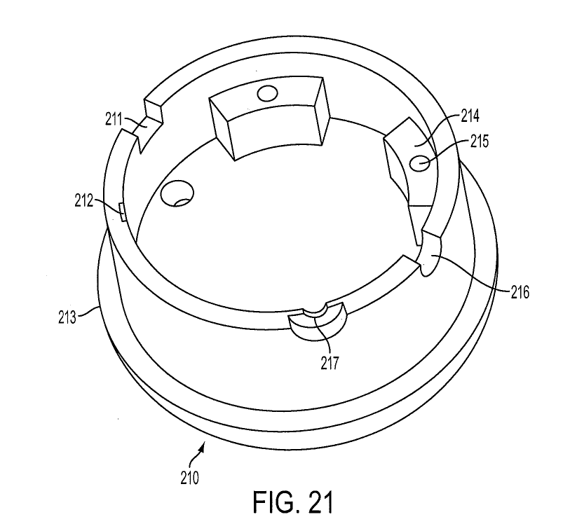

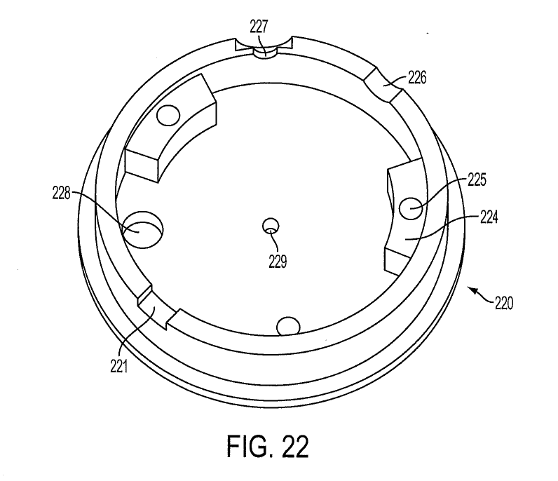

The top electronics case 220, an example of which is shown in FIG. 22, can include a headphone jack hole 226, an LED hole 227, and a power jack slot 221 corresponding to those in the bottom electronics case 210 shown in FIG. 21. Alternatively, holes for an LED, power jack, and headphone jack can be solely within either one of the bottom electronics case 210 and top electronics case 220. Similar to the bottom electronics case 210, the top electronics case 220 may include one or more hubs 224 and screw holes 225. The top electronics case 220 also may include at least one air hole 228 and a switch leg hole 229.

The air hole 228 may be provided to put the interior of the bottom cover 201 and the top cover 202 in fluid communication with each other. In this way, negative pressure can be created between the electronic stethoscope 200 and a body under observation. For example, the negative pressure can be created by an operator of the electronic stethoscope 200 squeezing the top cover 202 to force air out through the air hole 228 and unsqueezing the top cover 202 when the electronic stethoscope is applied to a body under observation. The relative negative pressure is thus created within the bottom cover 201 via the air hole 228 and the top cover 202.

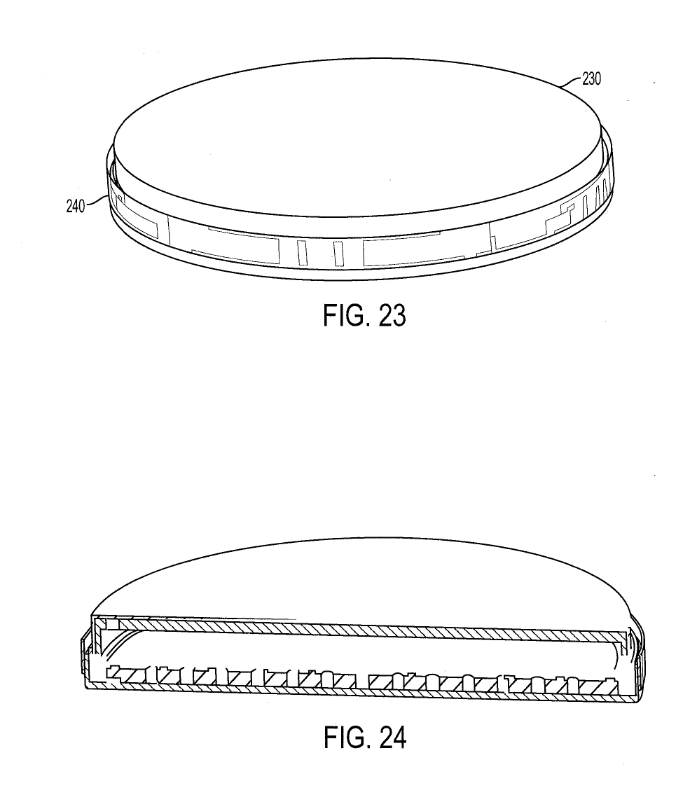

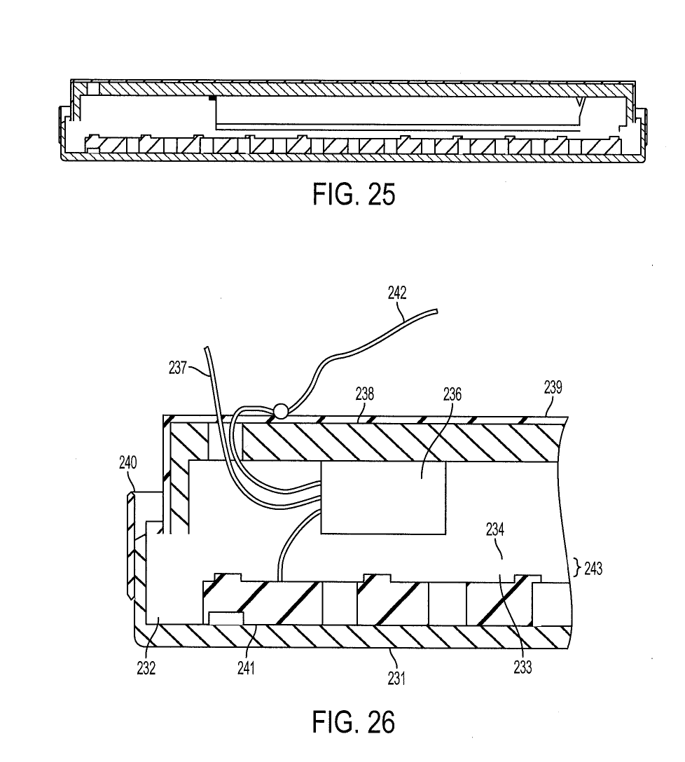

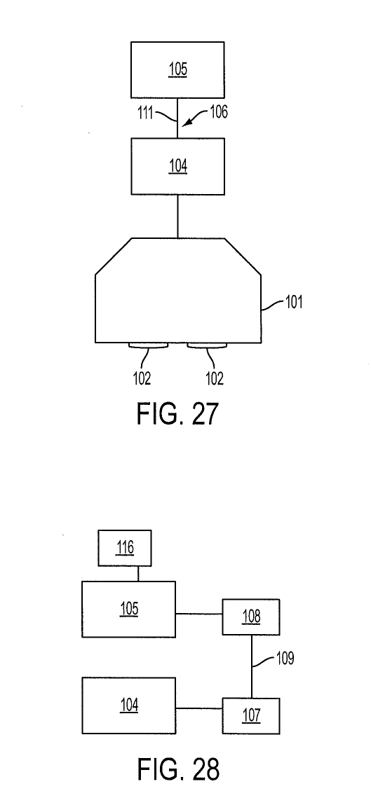

As shown in FIG. 20, the transducer 206 may be positioned below the electronics case assembly 203 and within the bottom cover 201, for example. The transducer 206 may further be contained within a transducer cover 230, as shown in FIG. 23. A cross-section of the transducer 206 is shown in FIGS. 24 and 25. The details revealed in these cross-sections are discussed below with respect to FIG. 26, which shows a close-up of the cross-section of the transducer 206.

As discussed above, transducer 206 of the electronic stethoscope 200 may be in the form of an electret microphone as shown in FIG. 26. Generally, a diaphragm of a microphone exposed to the environment is covered by a dust cap to prevent foreign matter from contaminating the performance. In the case where such a diaphragm is distorted by external interference, such as pressing the microphone against the human body to collect body sounds such as lung and heart sounds, the diaphragm may collapse or the sensitivity may change depending on how much force is applied. To eliminate these effects, an embodiment of the current invention uses an inverted electret microphone where the back plate is exposed to the patient, and since the back plate is a stiff material, the sensitivity of the electret microphone is independent of the force applied. The transducer 206 in FIG. 26 shows an example of such an electret microphone.

The transducer 206 includes microphone cover 231 that may be, for example, a nitrile rubber cover, or another polymer, rubber, or other material. Behind the microphone cover 231 is a back electrode 241 that is connected to a field-effect transistor (FET) 236 housed within a microphone case 238. In one embodiment, the microphone case 238 may be the product of a 3D printer. A drain 237 and ground 242 may be fed from the FET 236 through a hole in the microphone case 238, with the ground contacting a ground surface 239 positioned on top of the microphone case 238. The ground surface 239 can be, for example, aluminum foil.

The back electrode 241 can be made from a variety of materials, including, for example, stainless steel. A side of the back electrode 241 that is opposite to the microphone cover 231 is bordered by a multi-layer structure 243 including, for example, a polymer 233, fluorinated ethylene propylene (FEP) 232, and aluminum 234.

The transducer 206 may also be surrounded by a wrap 240, such as a PVC shrink wrap, for example.

### EXAMPLES

### Signal Detection by Working Device

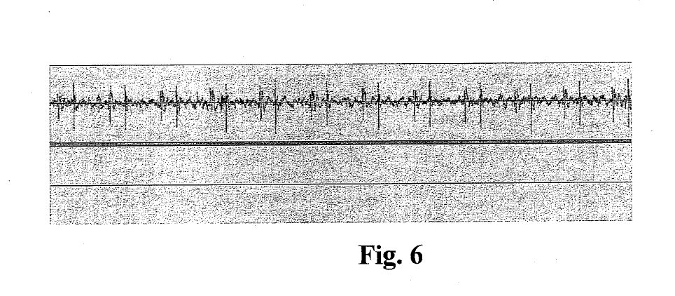

The following is a description of the performance of the device shown in FIG. 1, which is a prototype of an embodiment of the electronic stethoscope 100. The electronic stethoscope 100 in FIG. 1 was able to be paired to a computer via Bluetooth, with the detected signal being heard over the computer speakers. A signal from the computer's soundcard was fed to a computer program to capture the signal of a heartbeat, as shown in FIG. 6. In FIG. 6, the right channel is left open to accommodate for the addition of a signal from a noise cancelling microphone in some embodiments.

Study Background and Setup

A study was conducted to examine the content and the different signal components existing in lung sounds. Analysis was performed to detect and extract appropriate lung sound features that will contribute into further classifying patient cases or severity of condition. Findings and data from the studying are provided here to demonstrate the application of some aspects of the embodiments of the current invention.

Data was acquired through an electronic stethoscope. A microphone of the electronic stethoscope captured the auscultation sound, which was filtered, sampled and recorded. The recorded sounds were the input data of the analysis and most of the recorded sounds were about 2 minutes in length, sampled at 44100 Hz. In total there were 47 recordings from different patients. Recordings highly contaminated by noise were removed from validation. The recordings were then divided into segments of 15 seconds, with annotations available for every 15 second clip.

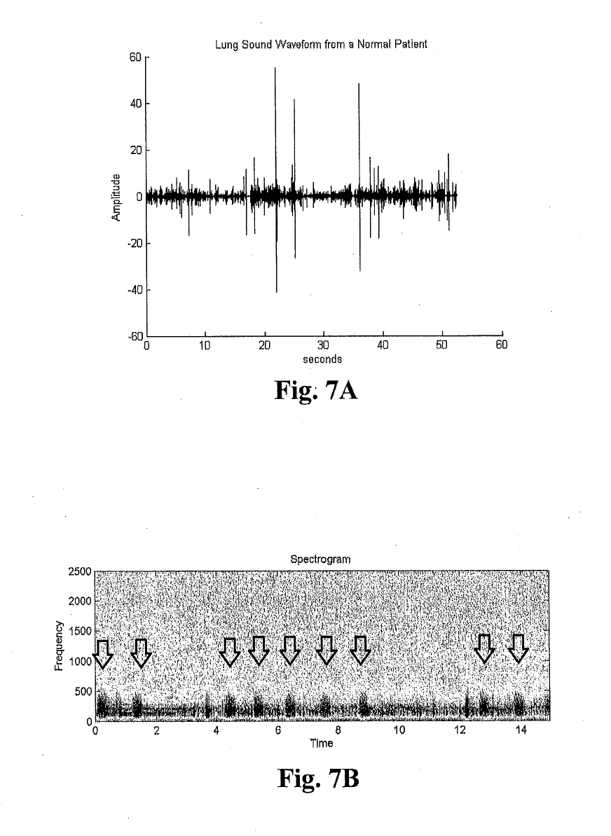

A typical lung sound, shown for example in FIG. 7A, contains frequency content in the range of 50-2500 Hz. The tracheal sounds also exist in this range and may even reach 4000 Hz. The lung sound is composed by various differently originated sounds. Stationary or continuous sounds may be found in a recording, such as wheeze or rhonchus, as well as non-stationary or discontinuous sounds like crepitations (fine or coarse scale). Wheezes and crackles are the most studied components of lung sounds and may indicate pathologies like asthma or respiratory stenosis, and pneumonia or lung infections accordingly. Other sounds contributing to the final recording are the heartbeat, the breathing sound, and unwanted noise.

The respiratory cycle consists of the inspiration and the expiration phase. A representation commonly used for visualization of the respiratory cycle is that of a spectrogram, allowing frequency, time and amplitude representation simultaneously. Such a representation may be seen in FIG. 7B.

Wheezes are on type of sounds heard in auscultation. Wheezes have a duration of more than 50-100 ms and less than 250 ms. The frequency content of wheezes is typically between 100 and 2500 Hz. Appearance of wheezes during specific times of the respiratory cycle may reveal or indicate different types of pathologies. Table 1 shows a short summary of wheeze characteristics and related conditions. Considering a time-frequency (x-y) representation, one would expect horizontal lines (during time) to reveal strong frequency components characterizing the presence of wheezes.

Crackles are another type of sound commonly heard. Crackles are short discontinuous sounds with duration of less than 20 ms, a frequency content ranging in the range of 100-200] Hz, and are usually associated with pulmonary dysfunction (pneumonia, lung infection). They usually originate by the opening of closed airways during the inspiration phase. The number of crackles appearing in a lung sound, the respiratory phase they appear in, and also their explicit waveform may indicate specific pathology case or reveal its severity. These sounds may be further divided into fine and coarse crackles, considering waveform characteristics like total duration, two cycle duration (duration between the beginning and the time where the waveform completes two cycles), etc. Table 1 shows a short summary of crackle characteristics and related conditions. In this case, considering a time-frequency (x-y) representation, one would expect vertical lines at specific time points to indicate the presence of impulsive signals.

TABLE 1
Characteristics of crackles and wheezes in lung sounds

| | Frequency | Duration | Respirat. cycle | Related condition |
|---|---|---|---|---|
| Crecipitations | 100-200 Hz | <20 ms | Inspiration (usu) | inflammation in |
| (aka Crackles) | | Short | | pulmonary tissue/airway |
| | | discont. | | (pneumonia) |
| Wheezes | 100-2500 Hz | 50-250 ms | Inspiration/ | Airway obstruction => |
| | | Continuous | Expiration | Asthma, respiratory |
| | | | | stenoses |

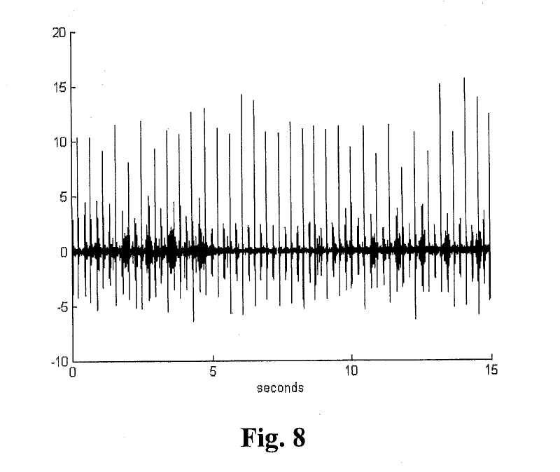

The heart beat in a lung sound signal may sometimes be considered noise, and thus filtering in frequency or time domains may be used for removing it from the acquired signal. FIG. 8 shows the high magnitude of the heart beat sound, possibly from the corresponding recording site being near the patient's heart. A reference signal (e.g., an EEG signal or a LEEG) may be used where the strongest component in the signal is the heart beat sound and is used to eliminate interference in the actual lung sound signal.

However, in the study described here, no extra reference signals (such as EEG-type recordings) were available to capture the heart beat interference and cancel it. Instead, the study attempted to detect the heartbeat through time-frequency representations. Also, while it may sometimes be desirable to remove the heartbeat from the signal, it is not always desirable to completely remove it from the analysis. A fast heart rate, for example, may indicate fear or stress by the child or patient, but it may also indicate a pulmonary disease when combined with other appropriate findings. Typical heart rates for various ages can be found in Table 2.

TABLE 2
Characteristics existing in a lung sound signal

| | Heart Rate (bpm) per age | | | | | | |
|---|---|---|---|---|---|---|---|
| | Age | | | | | | |
| | 1-3 wk | 1-6 mo | 6-12 mo | 1-3 yr | 4-5 yr | 6-8 yr | 9-11 yr |
| Heart | 105-180 | 110-180 | 110-170 | 90-150 | 65-135 | 60-130 | 60-110 |
| Rate | | | | | | | |

*Park MK. Park: Pediatric Cardiology for Practitioners, 5th ed. Philadelphia, PA: Mosby Elsevier; 2008

As discussed above, conductive noise might be present in a lung sound recording due to stethoscope movement. Background noise may also be present, including talking, crying or even interference of electronic devices. All of these kinds of noise are apparent in the dataset of the study described herein.

Acquisition of the data was performed using a single microphone and a simple mp3 recorder. The target population was young children. After acquisition, two physicians carefully examined and annotated the recorded signal by considering segments of 15 seconds. Each signal segment was annotated as containing crepitations (i.e., crackles), wheezes or bronchial sounds. Because the environment of the acquisition was not ideal, noise was also accounted for and recordings containing conductive or background noise were annotated accordingly. In total, 48 lung sounds were recorded. For the current study, each 15-second segment is considered as a separate case. As a start, only normal and crackle segments were considered, corresponding to normal and disease cases.

### Study Data and Analysis

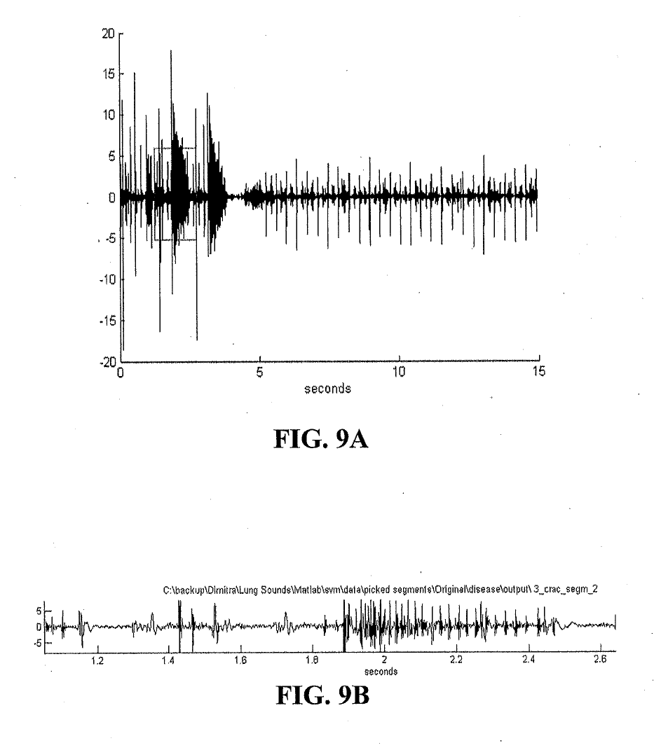

From the segments of recordings collected, twenty-seven segments were picked for further analysis. A typical crackling segment is shown in FIG. 9A, and FIG. 9B shows a zoomed-in view of the portion enclosed by a rectangle in FIG. 9A.

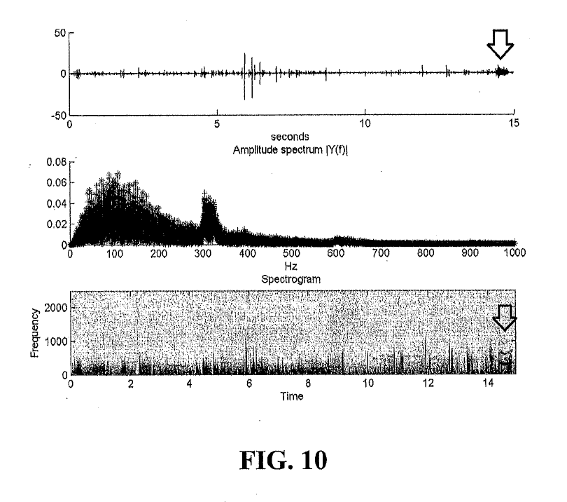

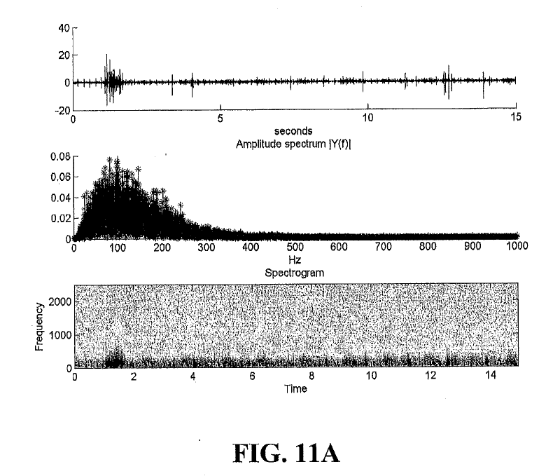

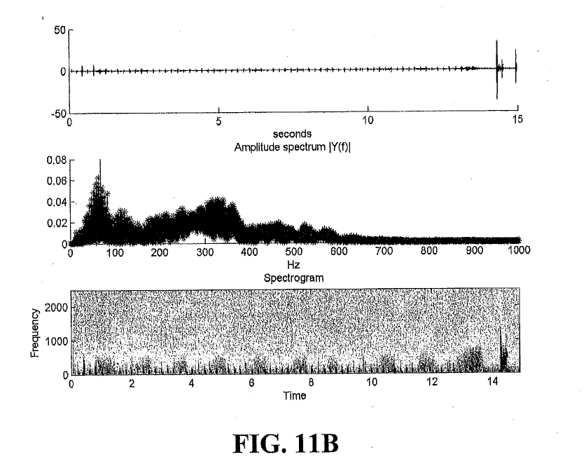

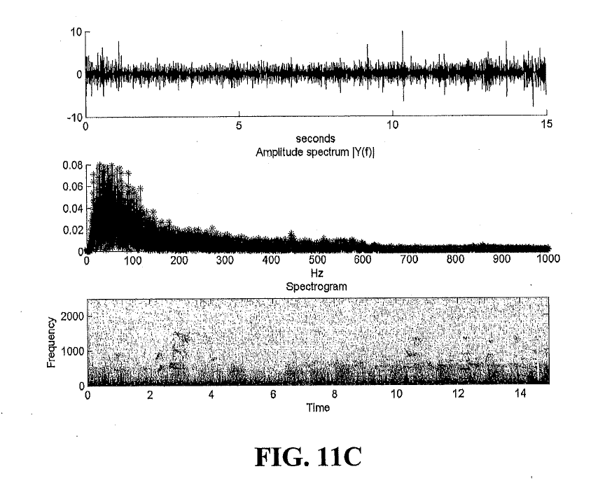

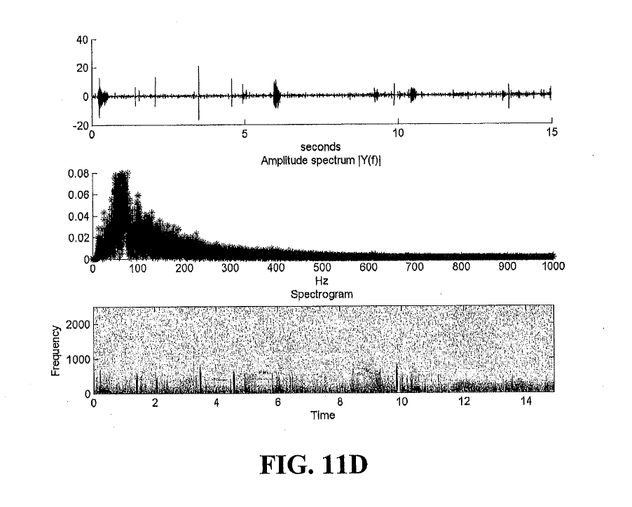

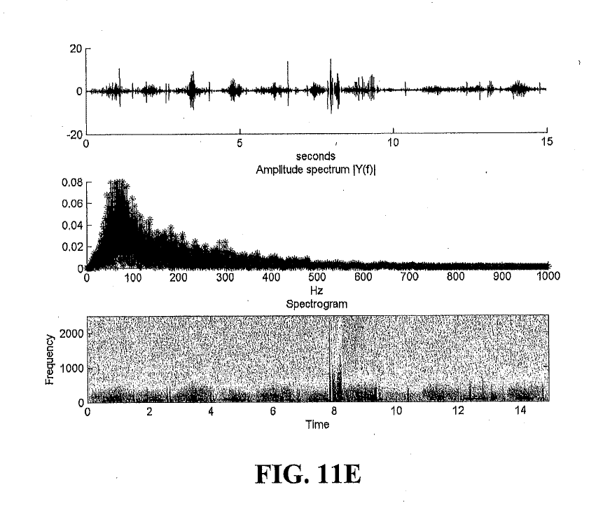

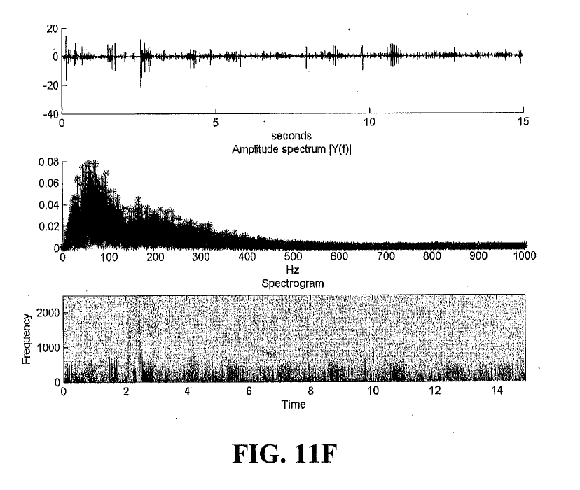

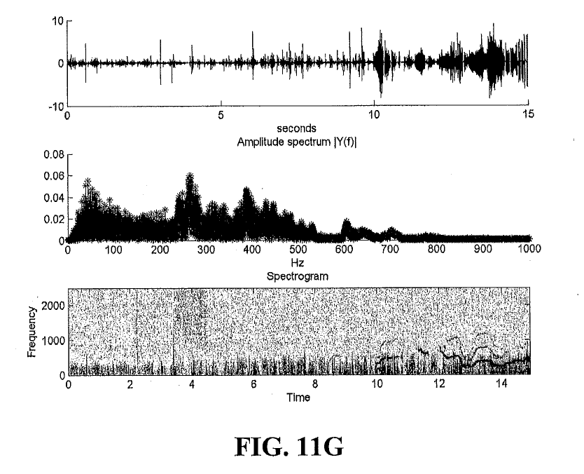

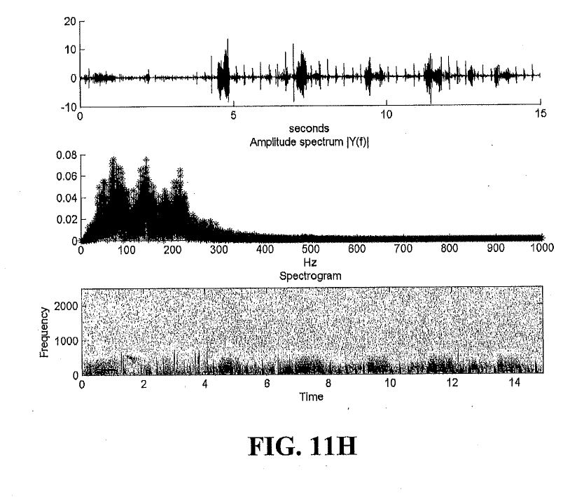

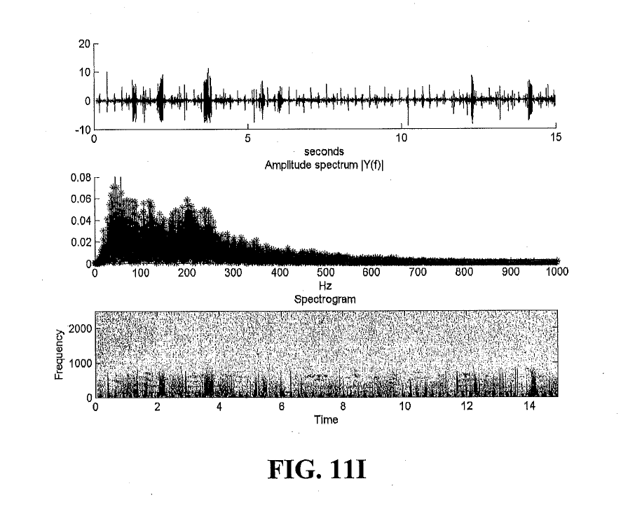

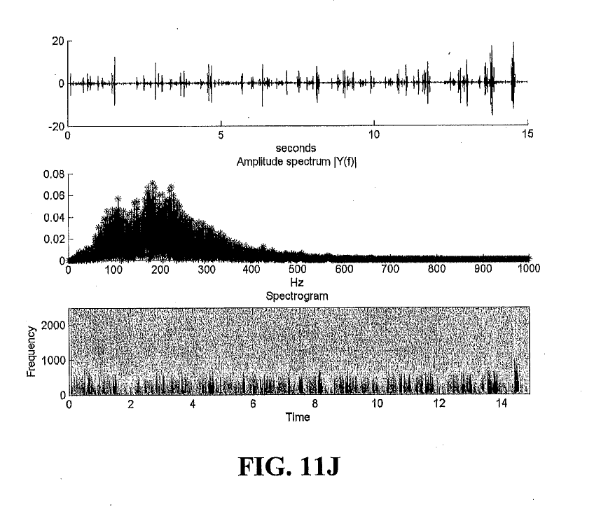

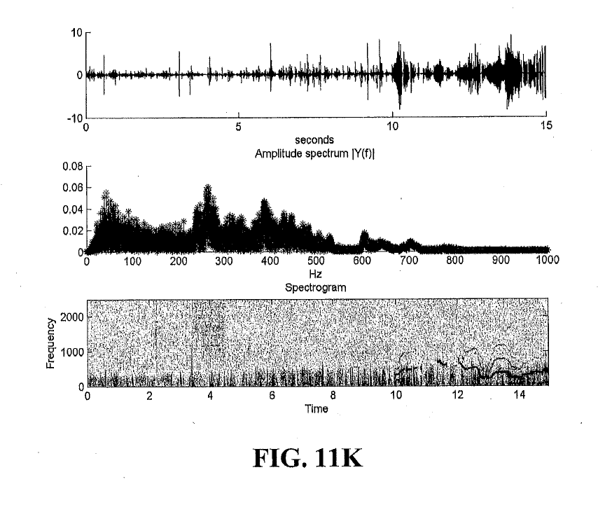

FIG. 10 shows a time-frequency (TF) representation of a 15 second segment. The specific segment was annotated during the study as containing crackles. The TF representation shows the possible appearance of noise at about the 14^{th} second. Except for a very few recordings from the study, recordings were contaminated by either background noise (e.g., conversations from a distance or mobile devices interfering with the microphone), cough, or conductive noise resulting in great amplitude peaks or in no actual recording due to misplacement. Such results indicate the prevalence of noise encountered during auscultation, and the need for tools to minimize or compensate for it. FIGS. 11A-11K show additional excerpts of segments from the study.

The dataset indicates not only the prevalence of noise and other sounds, but also the inconsistent or incomplete annotating performed by the physicians and the possible similarity of different sounds.

Analysis was performed using an algorithm for feature extraction of the lung sound excerpts. Each fifteen-second signal was further chopped into short-time excerpts of one, three, or five seconds to increase the data set. For each short-time excerpt, a scale-rate-frequency representation was calculated, considering both upward and downward responses (moving direction). The aim was to capture frequency contents and temporal modulations for each one of these segments and thus create the features that would be used in the next step, the classification algorithm. Input parameters were slightly changed in order to also capture rates less than 1 Hz. Classification was performed using supervised support vector machine (SVM) algorithm with a nonlinear kernel function: RBF K(x; z)=exp(−λx−zλ²/2σ²). A ten-fold cross validation outputted the accuracy of the model, and classification results may be found in Table 3.

Each row in Table 3 corresponds to a different run. For the interpretation of the results, sensitivity relates to the test's ability to identify positive results (proportion of people who have the disease (abnormal), over the total cases classified as having the disease). Sensitivity is defined as Sens=TP/(TP+FN), where the following notation used is TP=True Positives; TN=True Negatives; FP=False Positive; and FN=False Negative. Specificity relates to the ability of the test to identify negative results (people that are not abnormal, i.e. normal cases) and is defined as Spec=TN/(TN+FP).

TABLE 3
SVM classification on features obtained from the spectrotemporal analysis

| | | Sensitivity | Specificity | Accuracy |
|---|---|---|---|---|
| Picked excerpts | Break into 3-sec. | 40.00 | 85.71 | 66.67 |
| of 15 seconds. | w/out overlap | 90.00 | 61.54 | 73.91 |
| 27 normal vs | | 60.00 | 92.31 | 78.26 |
| 21 crackles | | 70.00 | 76.92 | 73.91 |
| | | 90.00 | 84.62 | 86.96 |
| | Break into 1-sec. | 30.00 | 90.24 | 64.79 |
| | w/out overlap | 60.00 | 70.73 | 66.20 |
| | | 60.00 | 58.54 | 59.15 |
| | Break into 5-sec. | 50.00 | 77.78 | 66.67 |
| | w/out overlap | 66.67 | 66.67 | 66.67 |
| | | 33.33 | 88.89 | 66.67 |
| Whole signals | Break into 3-sec. | 63.16 | 23.53 | 37.74 |
| ~105-120 sec. | w/out overlap | . . . | . . . | . . . |
| Normal vs | | | | |
| crackles + | | | | |
| wheeze | | | | |

The analysis included using a discrete wavelet transform (DWT). At each step of the DWT, the signal was passed through a high-pass filter and through a low-pass filter resulting in the first level detail and approximation coefficient, respectively. These filters cut the frequency bandwidth of the signal to half, and thus a downsampling was possible (downsample by 2) without loss of information. At the second step, the signal obtained after the low-pass filter is further passed through a high- and a low-pass filter, again halving the highest frequency component and again making a downsample by 2 possible. This may continue as much as the length of the signal allows.

For example, consider a signal acquired through a 16000 Hz sampling. The highest frequency component in the signal is therefore 8 kHz. At the first level of DWT decomposition, the detail coefficient will include the signal in frequency range of 4-8 kHz and the approximation coefficient will include the range of 0-4 kHz. The approximation coefficient component is downsampled by two, halving the original length. At the second level of decomposition the approximation coefficient of the first level is taken and further passed through a high- and a low-pass filter, thus obtaining the detail coefficient of level two at range 2-4 kHz, and the approximate coefficient of level two at range 0-2 kHz. The approximate coefficient of level 2 is downsampled by 2 before passing on to the third level decomposition, etc.

For this study, the original lung sound signals were resampled at a 16 kHz rate and the DWT transform was obtained for each of the 15-second segments, both for normal and crackled cases. This means that at the seventh level of decomposition the detail coefficient D7 includes frequency content 16 kHz*[1/2̂8-1/2̂7], i.e. 62.5-125 Hz and the approximate coefficient A7 contains frequencies at the range of 0-62.5 Hz.

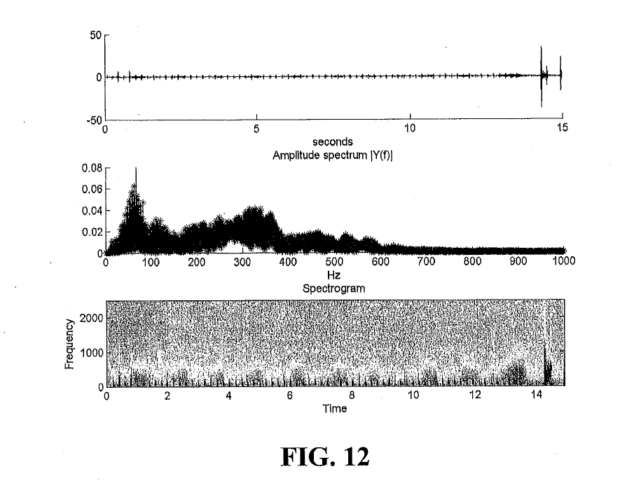

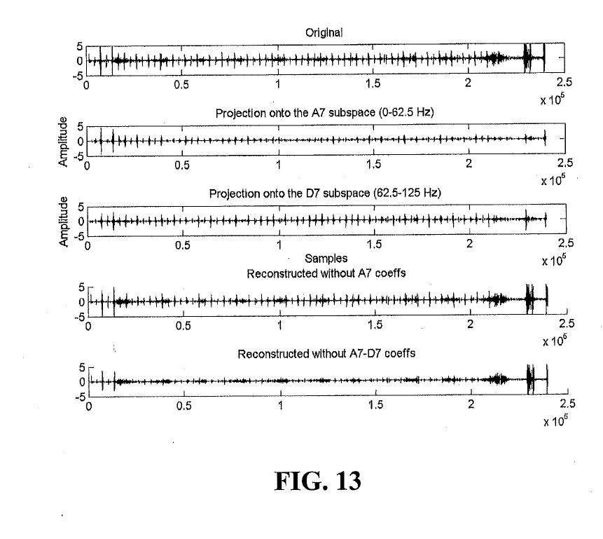

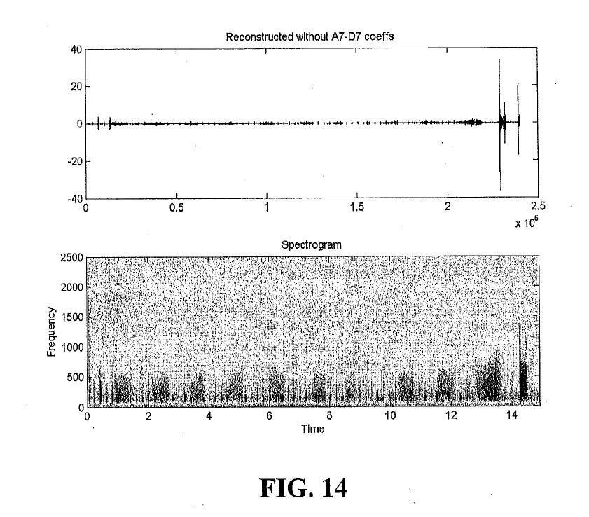

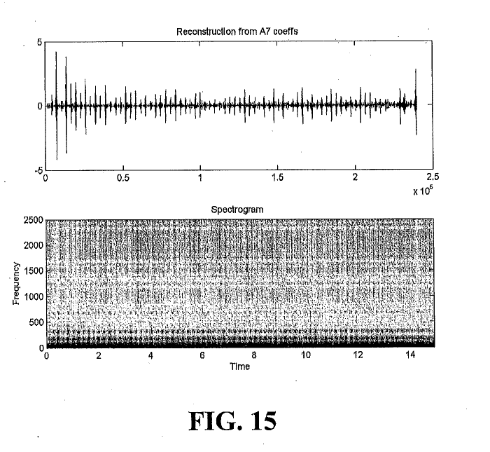

According to the above, the heartbeat, for example, may be extracted from the original signal without losing much information, by content in the frequency range of A7 being excluded and the signal being reconstructed by neglecting the content of A7. In another approach, content from both A7 and D7 was excluded. For example, FIG. 12 shows a normal 15-second segment (with coughing indicated by the high amplitude at the end of the segment). The signal was decomposed at level seven and the corresponding plots are shown in FIG. 13. While this example of the method may not entirely remove the heartbeat, similar processing may be performed for extracting the heartbeat or even eliminating from the original signal after a more thorough analysis. In addition, FIG. 14 shows the reconstructed signal when coefficients A7 and D7 are excluded. Further, FIG. 15 shows the spectrogram of the reconstructed signal using only coefficient A7, which reveals the heartbeat.

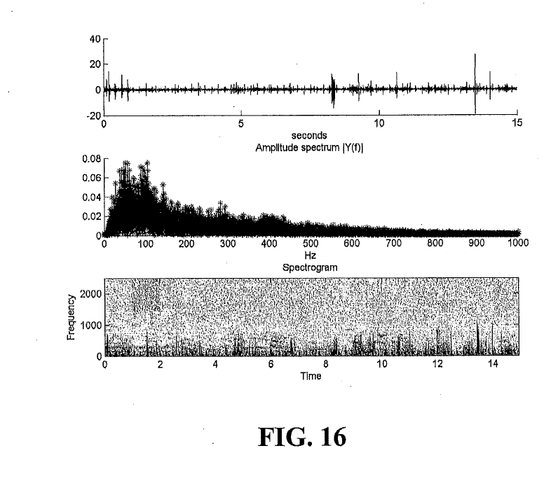

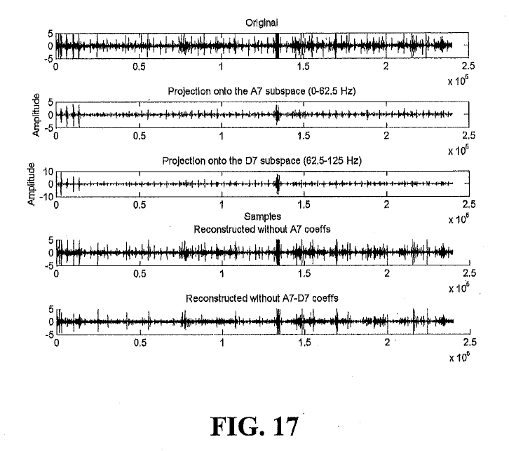

FIGS. 16 and 17 provide another example of the above-described signal processing. FIG. 16 shows representations of a 15-second segment containing crackling. FIG. 17 shows the signal of FIG. 16 after processing by decomposing the signal at level seven, including (from top to bottom): (1) the original excerpt with crackling; (2) the signal reconstruction based only on A7 coefficients; (3) the reconstruction based only on D7 coefficients; (4) the reconstruction excluding A7 coefficients; and (5) the reconstruction excluding both A7 and D7 coefficients.

Spectro-Temporal Modulation Feature Extraction

In another embodiment, a signal modeling and processing method is based on a biomimetic multi-resolution analysis of the spectro-temporal modulation details in lung sounds. The methodology provides a detailed description of joint spectral and temporal variations in the signal and proves to be more robust than frequency-based techniques in distinguishing crackles and wheezes from normal breathing sounds.

The framework presented here is based on biomimetic analysis of sound signals believed to take place along the auditory pathway from the point the signal reaches the ear, all the way to central auditory stages up to auditory cortex. Briefly, sound signals s(t) are analyzed through a bank of 128 cochlear filters h(t;f), modeled as constant-Q asymmetric bandpass filters equally spaced on a logarithmic frequency scale spanning 5.3 octaves. The cochlear output is then transduced into inner hair cell potentials via a high and low pass operation. The resulting auditory nerve signals undergo further spectral sharpening modeled as first-difference between adjacent frequency channels followed by half-wave rectification. Finally, a midbrain model resulting in additional loss in phase locking is performed using short term integration (or low-pass operator μ(t;τ) with constant τ=2 msec) resulting in a time frequency representation, the auditory spectrogram according to Equation (1).

y(t,f)=max[∂_{f}(∂ₜ(s(t)*h(t;f))),0]*μ(t;τ) (1)

At the central auditory stages, cortical neurons analyze details of the spectrographic representation, particularly the signal changes or modulations along both time and frequency. This operation is modeled as 2D affine Wavelet transform. Each filter is tuned (Q=1) to a specific temporal modulation ω₀ (or rate in Hz) and spectral modulation Ω₀ (or scale in cycles/octave or c/o), as well as directional orientation in time-frequency space (+ for upward and − for downward). For input spectrogram y(t;f), the response of each cortical neuron is given by:

r_{±}(t,f;ω₀,Ω₀)=y(t,f)_{t,f}STRF_{±}(t,f;ω₀,Ω₀) (2)

where μ_{t,f} corresponds to convolution in time and frequency and STRF_{±} is the 2D filter response of each cortical neuron. The resulting cortical representation is a mapping of the sound from a one-dimensional time waveform onto a high-dimensional space. In the current implementation, signals were sampled at 8 kHz and parsed onto 3-sec segments. For the two-class problem described later, the model included rate filters covering 0.5-32 Hz in logarithmic resolution. For the multi-class problem the cortical analysis included 10 rate filters in the range of 40-256 Hz and 7 scale filters in 0.125-8 c/o, also in logarithmic steps. The resulting cortical representation was integrated over time to maintain only three axes of rate-scale-frequency (R-S-F) and was augmented with a nonlinear statistical analysis using support vector machine (SVM) with radial basis function (RBF) kernels. Briefly, SVMs are classifiers that learn to separate the patterns of cortical responses caused by the lung sounds. The use of RBF kernels is a standard technique that allows one to map data from the original space onto a new linearly separable representational space. In the 2-class problem, normal versus abnormal segments were considered. In the multi-class problem categorization was divided into normal, crackle and wheeze sounds where 3 binary classifiers one-versus-all were built, SVM_{i,j}, i,jε{1, 2, 3}, i≠j. The final decision was based on a majority voting strategy. Each model performance was measured through a 10-fold cross validation with data split into 90-10% for training and testing.

For the diagnostic accuracy of the model different performance measures were used, all averaged over 10 independent Monte Carlo runs. In all cases the classification rates (CRs) are reported. For the two-class problem in particular, sensitivity (Sens), specificity (Spec) and AUC, the area under the Receiving Operating Characterictic curve (ROC) were used. For the three-class, a 3-way ROC analysis was calculated. There is an analogy of the 2-class ROC analysis to the 3-class case, where the volume under the ROC surface (VUS) expressed the probability that three chosen examples, one each from class 1, 2 and 3, will be classified correctly. Each example is represented by a triplet of probabilities (p₁, p₂, p₃), where Σᵢ^{k}pᵢ=1, and pᵢ=P(y=i|x) expressing the confidence that example x with label y belongs in class i. Plotting these triplets in a three dimensional coordinate space, all examples are bounded by the triangle with triplets (1, 0, 0), (0, 1, 0), (0, 0, 1). These vertices signify a 100% confidence that an example belongs to class 1, 2 or 3 respectively. VUS was obtained using Mossman's decision rule III on all randomly drawn trios: a trio of examples from each class 1, 2 and 3 is considered correctly rated if the sum of the lengths of the three line segments connecting each triplet with the triangle corner associated to its class is smaller than using any other combination to connect these triplets to the triangle corners. A discriminating test based on chance would obtain VUS=⅙. To compute pᵢ, we considered each one of the 2-class SVMᵢⱼ that discriminates between class i and j, with i≠j, i,jε{1, 2, 3}. We first need to find the pairwise class probabilities p_{i,j}=P(y=i|y=i or j,x), that vector x belongs in class i given SVMᵢⱼ and x. Assuming that distance d of x from the hyperplane, as outputted by SVMᵢⱼ is as informative as the input vector x, we estimate these probabilities by \hat{p}ᵢⱼ=P(y=i|y=i or j,d), by normalizing the corresponding distances to [0,1]. High probabilities are assigned to examples with greater distances. Notice that pⱼᵢ=1−pᵢⱼ. Having attained pᵢⱼ≈\hat{p}ᵢⱼ for every (i,j) pair, we seek the three posterior probabilities pᵢ=P(y=i|x). With k=3 classes, P(Uⱼ₌₁^{k}y=j|x)=P(U_{j=1,j≠1}^{k}=(y=j)∪(y=i)|x)=1, and Σ_{j=1,j≠1}^{k}P((y=1)∪(y=j)|x)−(k−2)P(y=i|x)=1, which yields:

$${p}_{i} = \frac{1}{{\sum }_{j = 1 , j \neq i}^{k} {( {p}_{ij} )}^{- 1} - ( k - 2 )} .$$

All pᵢ were further normalized so that Σᵢ^{k}pᵢ=1 holds, and express the confidence about the true class of example x.

This embodiment of the model does not include a denoising phase, but such a step could be incorporated or combined with this analysis. All acquired lung signals were downsampled and split as discussed earlier. Conductive and background noise-talking and/or crying was strongly apparent, rendering the accurate discrimination between normal and abnormal sounds a difficult task for annotating physicians.

The joint R-S-F representation of each sound was considered based on the cortical model presented earlier, where the SVM algortihm was able to discriminate normal and abnormal cases with Sens=89.44% and Spec=80.50%. To compare the benefit of the rate-scale representation over existing techniques, a feature extraction method was applied where the power spectrum of each excerpt was obtained and summed along the frequency axis ranging from 0-800 Hz to form a feature vector. A neural network was then used with two hidden layers for data classification. Since the focus is on the feature parameterization of lung sounds, the same SVM backend is needed to compare the present method to that of a known method called Spectral System (SS) in this study. We analyzed 3-sec segments with the SS system but varied the feature vector lengths from 10 to 100. Best average performance was achieved for length 90. The AUC values were 0.9217 for the R-S-F and 0.7761 for the SS model. Summary results are presented in Table 4 in the form of a confusion matrix. Columns correspond to outcomes, rows to true annotations and the diagonal depicts the correct classification % rates.

TABLE 4
Average classification rates % of the 2-class problem

| | R-S-F Output | | SS Output | |
|---|---|---|---|---|
| True Annotation | Normal | Abnormal | Normal | Abnormal |
| Normal | 80.50 | 19.50 | 70.25 | 29.75 |
| Abnormal | 10.56 | 89.44 | 18.33 | 81.67 |

Average AUC values for R-S-F: 0.9217 and for SS: 0.7761

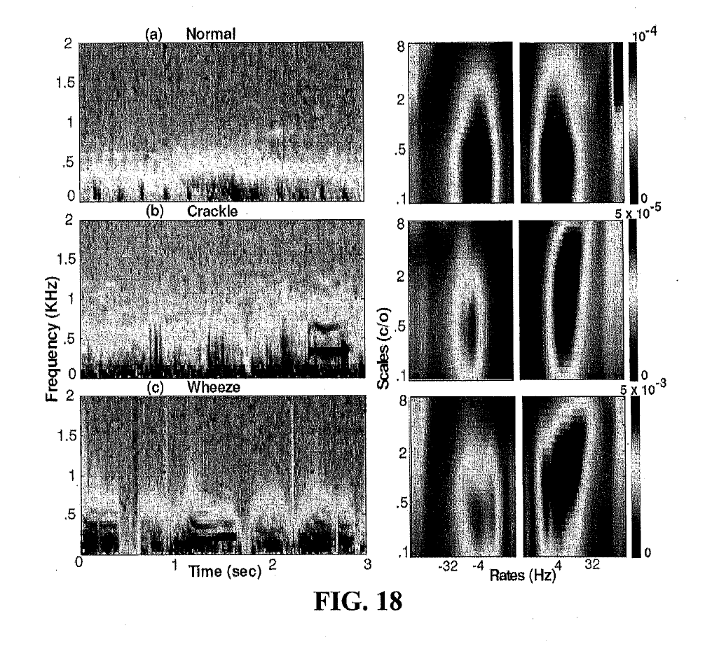

In order to understand the difficulties of classification of the lung sounds and the ability of the proposed feature dimensions to capture the lung sound characteristics, FIG. 18 is presented. FIG. 18 shows time-frequency (column 1) and rate-scale (column 2) representations of data used in the study. FIG. 18(a) shows a spectrogram of a normal subject. Immediately clear are circular breathing patterns. However, also apparent are noise-like patterns (time 1.2-2.8 seconds) that could be easily confused with transient events like crackles. The right panel shows the rate-scale representation based on the cortical analysis of the same signal segment. The figure highlights the presence of a periodic breathing cycle at 4 Hz. Strong energy at both positive and negative temporal modulations suggests that the signal fluctuates at 4 Hz with no particular upward or downward orientation. Spectrally, the rate-scale pattern shows a concentration of energy in lower scales (<1 c/o). This pattern is again reflective of the broadband-like nature of breathing patterns as well as transient noise events. In contrast, FIG. 18(b)-(c) depict similar spectrograms and rate-scale patterns for a diagnosed crackle and wheeze case, respectively. The spectrograms of both cases contain patterns that may easily be confused as wheeze-like. FIG. 18(b) at time 2.5-2.8 sec depicts a “crying” interval, not easily discernible as a non-wheeze event (contrast with 1.1-1.7 seconds of FIG. 18(c)). On the other hand, the asymmetry of the rate-scale pattern for both cases begins to show clearer distinction between normal and crackling and wheezing events. Note that the color bar of rate-scale plots on all cases is different, even though spectrograms were normalized to same level. This is indicative of differences in modulation strength in the signal along both time and frequency.

The importance of these feature dimensions can be further investigated considering the more difficult task of a 3-class problem. Exploiting both symmetry and intensity differences in the rate scale representation a discrimination among normal, crackles and wheeze segments is possible through the joint R-S-F setup, as described in the methods, yieldng a VUS score 0.601. Recall that a classifier based on chance would achieve VUS=0.167. Detailed CRs may be found in Table 5 revealing that crackle segments (explosive and short in duration) are more difficult to discriminate, often confused with noise contaminating normal segments. To judge the significance of the frequency components information in the feature vector, all frequency information was averaged resulting in the joint Rate-Scale (R-S) representation (patterns in column 2 of FIG. 18), with VUS=0.729 and CRs as shown in Table 5. Corresponding results on the 2-class problem showed Sens=90.22%, Spec=73.50%, AUC=0.9219. A possible reason for the performance jump in the 3-class case compared to the R-S-F representation, could be that knowledge of the specific frequency bands of the abnormal sounds add non-informative details to the model. Another explanation could be the sound set size: not having access to adequate number of abnormal lung sound recordings with enough frequency range variability could be also affecting the performance. It is unclear at this point how much frequency localized are the specific sound patterns and whether the frequency coverage correlates with specific pathological or ecological substrates. Further investigation is ongoing to gain more insight into the nature of the data.

TABLE 5
Average classification rates % of the 3-class problem for the proposed method

| True | R-S-F Output | | | R-S Output | | | [R,S] Output | | |
|---|---|---|---|---|---|---|---|---|---|
| Annotation | Normal | Crackle | Wheeze | Normal | Crackle | Wheeze | Normal | Crackle | Wheeze |
| Normal | 77.49 | 10.01 | 12.50 | 76.75 | 16.50 | 6.75 | 76.07 | 11.79 | 12.14 |
| Crackle | 21.25 | 39.25 | 39.50 | 19.50 | 45.76 | 34.74 | 20.71 | 50.35 | 28.93 |
| Wheeze | 20.60 | 23.20 | 56.20 | 10.02 | 16.38 | 73.60 | 10.00 | 21.71 | 68.29 |

Average VUS values for R-S-F: 0.601, for R-S: 0.729 and for [R,S]: 0.608

Finally, the importance of having such a joint spectro-temporal modulation space was investigated. To this effect, the relevance of the marginal feature dimensions for rates and scales was assessed, where we considered the rate alone feature vector extending the scale representation ([R,S]) and the achieved 3-class VUS score was 0.6075 and the 2-class AUC was 0.8572. CRs are shown in Table 5. The joint R-S representation appears more informative in discriminating between the sounds of interest, compared to both rates and scales in a concatenated vector.

Thus, according to the above, an automated multi-resolution analysis of lung sounds can be performed where SVM classifiers are trained on the different extracted features and evaluated using correct classification rates and VUS scores, and measuring the discriminating ability among normal, crackle and wheeze cases. The observed results from the above study revealed that lung sounds contain more informative details than the time-frequency domain can capture. Temporal and spectral modulation features are able to increase the discrimination capability compared to features based only on frequency axis. A joint rate-scale representation is able to perform sufficient discrimination even in noisy sound segments where talking and crying can impede or complicate the identification of abnormal sounds.

Further, it is understood that additional pre-processing of sounds by applying denoising techniques to, for example, background and conductive noise. In addition, it is possible to extract the breathing cycle from the detected signal, and thus isolate events related to inspiration or expiration, leading to a more accurate discrimination of abnormal sounds, as indicators of pulmonary conditions and their severity.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

### REFERENCES

1. D. Emmanouilidou, K. Patil, J. West, M. Elhilali. 2012. A multiresolution analysis for detection of abnormal lung sounds. Conf Proc IEEE Eng Med Biol Soc. 3139-42.
2. Kraman, S. S., Wodicka, G. R., Oh, Y. and Pasterkamp, H. 1995. Measurement of respiratory acoustic signals. Effect of microphone air cavity width, shape, and venting. Chest, 108:1004-8
3. Mazic, J., Sovilj, S. and Magjarevic, R. 2003. Analysis of respiratory sounds in asthmatic infants. Polytechnic of Dubrovnik, Measurement Science Review, 3:11-21.
4. Fiz, J. A., Jane, R., Homs, A., Izquiero, J., Garcia, M. A. and Morera, J. 2002. Detection of wheezing during maximal forced exhalation in patents with obstructed airways. Chest, 122:186-91.
5. Albers, M., Schermer, T., van den Boom, G., Akkermans, R., van Schayck, C., van Herwaarden, C. and Weel, C. 2004. Efficacy of inhaled steroids in undiagnosed subjects at high risk for COPD: results of the detection, intervention, and monitoring of COPD and asthma. Chest, 126:1815-24.
6. Meslier, N., Charbonneau, G. and Racineux, J-L. 1995. Wheezes. Eur. Respir. J., 8:1942-8
7. Piirila, P. and Sovijarvi, A. R. 1995. Crackles: recording, analysis and clinical significance. Eur. Respir. J., 8:2139-48.
8. Mascagni, O. and Doyle, G. A. 1993. “Infant distress vocalizations in the southern african lesser bushbaby”. International Journal of Primatology, 14(1):41-60.
9. Sovijarvi, A. R., Malmberg, L. P., Charbonneau, G. and Vandershoot, J. 2000. Characteristics of breath sounds and adventitious respiratory sounds. Eur. Respir. Rev., 10:591-6.
10. Iyer, V. K., Rammoorthy, P. A., Fan, H. and Ploysongsang, Y. 1996. “Reduction of heart sounds from sounds by adaptive filtering”. IEEE Transactions on Biomedical Engineering, 33(12):1141-8.
11. Park MK. Park: Pediatric Cardiology for Practitioners, 5th ed. Philadelphia, Pa.: Mosby Elsevier; 2008
12. R. J. Riella, P. Nohama, and J. M. Maia, “Method for automatic detection of wheezing in lung sounds.” Brazilian Journal of Medical and Biological Research, vol. 42, no. 7, pp. 674-684, 2009.
13. T. Chi, P. Ru, and S. Shamma, “Multiresolution spectrotemporal analysis of complex sounds,” Journal of the Acoustical Society of America, vol. 118, pp. 887-906, 2005.
14. L. E. Ellington, R. H. Gilman, J. M. Tielsch et al., “Computerised lung sound analysis to improve the specificity of paediatric pneumonia diagnosis in resource-poor settings: protocol and methods for an observational study,” BMJ open, vol. 2, p. e000506, 2012.
15. A. A. Abaza, J. B. Day, J. S. Reynolds, A. M. Mahmoud, W. T. Goldsmith, W. G. McKinney, E. L. Petsonk, and D. G. Frazer, “Classification of voluntary cough sound and airflow patterns for detecting abnormal pulmonary function.” Cough, vol. 5, p. 8, 2009.
16. A. Gurung, C. G. Scrafford, J. M. Tielsch, O. S. Levine, and W. Checkley, “Computerized lung sound analysis as diagnostic aid for the detection of abnormal lung sounds: a systematic review and meta-analysis.” Respir Med, vol. 105, no. 9, pp. 1396-1403, September 2011.
17. S. Reichert, R. Gass, C. Brandt, and E. Andres, “Analysis of respiratory sounds: state of the art.” Clinical medicine Circulatory respiratory and pulmonary medicine, vol. 2, pp. 45-58, 2008.
18. S. A. Taplidou, L. J. Hadjileontiadis, I. K. Kitsas et al., “On applying continuous wavelet transform in wheeze analysis.” Conference Proceedings of the International Conference of IEEE Engineering in Medicine and Biology Society, vol. 5, pp. 3832-3835, 2004.
19. B. Flietstra, N. Markuzon, A. Vyshedskiy, and R. Murphy, “Automated analysis of crackles in patients with interstitial pulmonary fibrosis,” Pulmonary medicine, vol. 2011, no. 2, p. 590506.
20. K. K. Guntupalli, P. M. Alapat, V. D. Bandi, and I. Kushnir, “Validation of automatic wheeze detection in patients with obstructed airways and in healthy subjects,” The Journal of asthma official journal of the Association for the Care of Asthma, vol. 45, pp. 903-907, 2008.
21. L. R. Waitman, K. P. Clarkson, J. A. Barwise, and P. H. King, “Representation and classification of breath sounds recorded in an intensive care setting using neural networks.” Journal of Clinical Monitoring and Computing, vol. 16, no. 2, pp. 95-105, 2000.
22. Y. P. Kahya, M. Yeginer, and B. Bilgic, “Classifying respiratory sounds with different feature sets.” Conference Proceedings of the International Conference of IEEE Engineering in Medicine and Biology Society, vol. 1, pp. 2856-2859, 2006.
23. X. Lu and M. Bahoura, “An integrated automated system for crackles extraction and classification,” Biomedical Signal Processing And Control, vol. 3, no. 3, pp. 244-254, 2008.
24. A. Kandaswamy, C. S. C. S. Kumar, R. P. Ramanathan, S. Jayaraman, and N. Malmurugan, “Neural classification of lung sounds using wavelet coefficients,” Computers in Biology and Medicine, vol. 34, no. 6, pp. 523-537, 2004.
25. N. Cristianini and J. Shawe-Taylor, Introduction to support vector machines and other kernel-based learning methods. Cambridge, UK: Cambridge University Press, 2000.
26. D. Mossman, “Three-way rocs,” Medical Decision Making, vol. 19, no. 1, pp. 78-89, 1999.
27. D. Price and S. Knerr, “Pairwise neural network classifiers with probabilistic outputs,” Processing, vol. 7, pp. 1109-1116, 1995.

We claim:

1. An electronic stethoscope, comprising:
an acoustic sensor assembly having a plurality of microphones arranged in an acoustic coupler to provide a plurality of pick-up signals;
a detection system configured to communicate with said acoustic sensor assembly and configured to combine said plurality of pick-up signals to provide a detection signal; and
an output system configured to communicate with said detection system,
wherein said acoustic coupler comprises a compliant material that forms an acoustically tight seal with a body under observation.

2. The electronic stethoscope according to claim 1, wherein said detection system further comprises a wireless transmitter and said output system comprises a wireless receiver configured to provide a wireless communication link between said detection system and said output system.

3. The electronic stethoscope according to claim 2, wherein said wireless transmitter is a radio frequency wireless transmitter and said wireless receiver is a radio frequency wireless receiver.

4. The electronic stethoscope according to claim 3, wherein said radio frequency wireless transmitter is a Bluetooth radio frequency wireless transmitter and said radio frequency wireless receiver is a Bluetooth radio frequency wireless receiver.

5. The electronic stethoscope according to claim 1, wherein said output system comprises headphones.

6. The electronic stethoscope according to claim 5, wherein said detection system and said headphones are configured to communicate over a hard-wired communication link.

7. The electronic stethoscope according to claim 6, wherein said hard-wired communication link is at least one of an electrical wire or an optical fiber.

8. The electronic stethoscope according to claim 2, wherein said output system comprises headphones, and
wherein said headphones comprise said wireless receiver configured to provide said wireless communication link between said detection system and said headphones.

9. The electronic stethoscope according to claim 1, wherein said output system comprises a data storage device.

10. The electronic stethoscope according to claim 9, wherein said data storage device comprises a removable data storage component.

11. The electronic stethoscope according to claim 1, further comprising a microphone arranged external to said acoustic coupler to receive external acoustic signals from sources that are external to said body under observation,
wherein at least one of said detection system and said output system is further configured to perform a correction of said detection signal based on said external acoustic signals.

12. The electronic stethoscope according to claim 11, wherein said correction includes at least partially filtering said external acoustic signals from said detection signal.

13. The electronic stethoscope according to claim 11, wherein said correction is based on a waveform characteristic of said external acoustic signal.

14. The electronic stethoscope according to claim 1, wherein said output system comprises a data processing system configured to perform an identification of at least one of a physical process and a physiological condition of said body based on said detection signal.

15. The electronic stethoscope according to claim 14, wherein said identification is based on at least one of a temporal characteristic and a spectral characteristic of said detection signal.

16. The electronic stethoscope according to claim 1 wherein the output system is further configured to provide aural or visual feedback to a user of the electronic stethoscope.

17. The electronic stethoscope according to claim 1, wherein the acoustic sensor assembly is configured to provide a negative pressure between said plurality of microphones and said body under observation and to thereby stay in a fixed position on said body under observation in a hands-free manner.

18. An electronic stethoscope, comprising:
an acoustic sensor assembly including:
a microphone arranged in an acoustic coupler to provide a detection signal from a body under observation, and
a microphone arranged external to said acoustic coupler to receive external acoustic signals from sources that are external to said body under observation;
a detection system configured to communicate with said acoustic sensor assembly; and
an output system configured to communicate with said detection system,
wherein at least one of said detection system and said output system is further configured to perform a correction of said detection signal based on said external acoustic signals.

19. The electronic stethoscope according to claim 18, wherein said correction at least partially filters said external acoustic signals from said detection signal.

20. The electronic stethoscope according to claim 18, wherein said correction is based on a characteristic of at least one of said external acoustic signal and said detection signal.

21. An electronic stethoscope, comprising:
an acoustic sensor assembly having an inverted electret microphone arranged in an acoustic coupler to provide a pick-up signal;
a detection system configured to communicate with said acoustic sensor assembly and configured to convert said pick-up signal into a detection signal; and
an output system configured to communicate with said detection system,
wherein said acoustic coupler comprises a compliant material that forms an acoustically tight seal with a body under observation.

22. The electronic stethoscope according to claim 21, wherein
said pick-up signal is comprised of a plurality of sub-signals, and
said detection system is configured to combine said plurality of sub-signals to provide said detection signal.

23. An electronic stethoscope, comprising:
an acoustic sensor assembly having a piezo-electric polymer transducer arranged in an acoustic coupler to provide a pick-up signal;
a detection system configured to communicate with said acoustic sensor assembly and configured to convert said pick-up signal into a detection signal; and
an output system configured to communicate with said detection system,
wherein said acoustic coupler comprises a compliant material that forms an acoustically tight seal with a body under observation.

24. The electronic stethoscope according to claim 23, wherein
said pick-up signal is comprised of a plurality of sub-signals, and
said detection system is configured to combine said plurality of sub-signals to provide said detection signal.

25. A method for processing signals detected by an electronic stethoscope from a body under observation, comprising:
obtaining a signal captured by said electronic stethoscope;
identifying a part of said signal that corresponds to at least one of a noise external to said body under observation and an internal sound of said body; and
selectively removing at least a portion of said part of said signal.

26. The method for processing signals according to claim 25, wherein said part of said signal is identified according to at least one of a frequency characteristic and a time characteristic of said part of said signal.

27. The method for processing signals according to claim 25, wherein said part of said signal is identified based on a reference signal.

28. The method for processing signals according to claim 25, further comprising performing a discrete wavelet transformation of said signal, said transformation comprising:
filtering said signal in a plurality of steps, each step including:
applying a high-pass filter and a low-pass filter to said signal,
obtaining a first coefficient and a second coefficient as a result of applying said high-pass filter and said low-pass filter, respectively, and
downsampling said signal after applying said high- and low-pass filters; and
transforming said signal based on at least one said first coefficient and said second coefficient obtained from at least one of said plurality of steps of filtering.
